(19) United States
(12) Patent Application Publication
(10) Pub. No.: US 2004/0137142 A1
(43) Pub. Date: Jul. 15, 2004

(54) Method for manufacturing organic electroluminescence panel

(76) Inventor: Ryuji Nishikawa, Gifu-shi (JP)

Correspondence Address: CANTOR COLBURN, LLP, 55 GRIFFIN ROAD SOUTH, BLOOMFIELD, CT, 06002

(21) Appl. No.: 10/714,431

(22) Filed: Nov. 13, 2003

(30) Foreign Application Priority Data
Nov. 14, 2002 (JP) 2002-331418

(51) Int. Cl. B05D 5/12; B05D 3/00

(52) U.S. Cl. 427/66; 427/555; 427/68

(57) ABSTRACT

A layer of an organic insulating material which functions as a laser removal layer, preferably, a layer of an organic insulating material used during manufacture of an organic EL panel, is formed over a terminal formed when an organic EL element is formed or a TFT for driving the organic EL element is formed. After the organic EL element is formed, a protection film is formed to cover an entire surface of the panel substrate and laser light which can be absorbed by the layer on the terminal covered by the protection film and made of the organic insulating material is irradiated to cause ablation in this layer so that the layer of the organic insulating material and the protection film are simultaneously removed to expose the terminal.

### BACKGROUND OF THE INVENTION

1. Field of the Invention

The present invention relates to an organic electroluminescence panel, and, in particular, to a terminal in an organic electroluminescence panel for connection to an external structure.

2. Description of the Related Art

Because electroluminescence (hereinafter simply referred to as “EL”) panels, in which a self-emitting EL element is used as an emissive element in each pixel, have advantages such as that the device is thin, self-emitting, and consumes less power, EL panels have attracted much attention as alternatives to display devices such as liquid crystal display (LCD) and cathode ray tube (CRT) display devices.

An organic EL element has a structure in which an organic layer including organic emissive molecules is provided between an anode and a cathode. Holes injected from the anode and electrons injected from the cathode recombine in the emissive layer to excite the organic emissive molecules, and light is emitted when the emissive molecules return to their ground state.

Although such organic EL elements have a number of advantages such as achievement of light of various color at a high brightness depending on the organic emissive molecules, the organic EL elements also have disadvantages that the organic layer is easily degraded by moisture and oxygen and that the organic EL element has low mechanical strength. Because of this, there is a need to provide a protection structure for protecting the element, in particular, the organic layer, from moisture, oxygen, etc.

As the structure for protection, a method for covering a plane, of an organic EL element formed on a substrate, opposite to the plane facing the substrate with a protection film is advantageous in view of reduced thickness, size, and weight.

In order to actually operate the organic EL panel, it is necessary to form, on the substrate, a connection terminal to the outside for making connection to some kind of external power supply in order to drive the element, and to expose this terminal.

On the other hand, in order to form a protection film for covering the organic EL element with superior coverage, it is desirable to form the protection film over the entire surface of the substrate. Thus, for the portion of the terminal, a method can be considered in which a protection film is formed over the entire surface of the substrate and then, the protection film over the terminal portion is removed by wet etching through photolithography. In order to reliably protect the organic layer from moisture or the like, however, it is desirable to avoid applying a wet etching process after the organic layer is formed.

Therefore, a method must be employed in which a metal mask or the like is used during formation of the protection film so that protection film is selectively not formed over the terminal portion. However, when the protection film is formed using a mask, a method which can achieve high coverage and highly even flatness, such as spin coating, cannot be used to form the protection film.

### SUMMARY OF THE INVENTION

The present invention advantageously provides an organic EL panel in which a connectable terminal is formed on the panel without adversely affecting the organic layer.

According to one aspect of the present invention, there is provided a method for manufacturing an organic electroluminescence panel having an organic electroluminescence element and a terminal for external connection for driving the organic electroluminescence element, the organic electroluminescence element having an organic layer including a light emitting molecule between a lower electrode and an upper electrode, wherein a laser removal layer made of a laser absorbing material is formed to cover a formation region of the terminal for external connection; after the laser removal layer is formed, a protection film is formed to cover the organic electroluminescence element and the laser removal layer; and laser having a wavelength in an absorption wavelength range of the laser absorbing material is irradiated toward a region in which the laser removal layer is formed so that the laser removal layer and the protection film formed above the laser removal layer are removed and an upper surface of the terminal for external connection is exposed.

By forming a laser absorbing material which absorbs laser light to cover a terminal for external connection and selectively irradiating laser light onto a formation region of a laser removal layer made of the laser absorbing material, the laser removal layer is heated in the irradiated region, the laser removal layer and the protection film formed over the laser removal layer can be simultaneously removed, and a terminal formed below the laser removal layer can be exposed. Therefore, the protection film can be formed over the entire surface of the panel region without a limitation, and it is possible to reliably protect the organic layer or the like by covering the organic electroluminescence element with a uniform protection film having superior coverage. In addition, because this process is a dry etching process using laser irradiation, it is possible to expose the terminal for external connection without affecting the organic layer.

According to another aspect of the present invention, it is preferable that, in the method for manufacturing an organic electroluminescence panel, an organic insulating layer is formed at least partially covering end portions of each of the lower electrodes formed individually for each pixel, and, simultaneously, the organic insulating layer is formed over the formation region of the terminal for external connection as the laser removal layer.

According to another aspect of the present invention, it is preferable that, in the method for manufacturing an organic electroluminescence panel, a plurality of organic electroluminescence elements are formed on the panel substrate; and an organic insulating layer is formed to separate, by each lower electrode or by each upper electrode, at least a portion of the organic layer of the organic electroluminescence element and the organic insulating layer is simultaneously formed over the formation region of the terminal for external connection as the laser removal layer.

In this manner, by using, as the laser removal layer, an organic insulating layer which is used in a process for forming an organic electroluminescence element, it is possible to expose the terminal for external connection without adding a special process and without a risk of intrusion of moisture or the like into the organic layer.

According to another aspect of the present invention, it is preferable that, in the method for manufacturing an organic electroluminescence panel, as the organic insulating layer or the laser removal layer, it is possible to employ a planarizing insulating layer containing a photosensitive material. Because a planarizing insulating layer containing a photosensitive material is used, it is easy to selectively leave the planarizing insulating layer in the formation region of the terminal for external connection, an end region of the lower electrode, and regions in each of lower and upper electrodes after the planarizing insulating layer is formed over the entire surface of the substrate. In addition, because many materials for the planarizing insulating layer are also materials that selectively absorb laser light, the material is also superior as a material for the laser removal layer. Therefore, it is possible to easily expose the terminal using the planarizing insulating layer.

According to another aspect of the present invention, it is preferable that, in the method for manufacturing an organic electroluminescence panel, the protection film is a laser transmitting film which allows the laser light to transmit through. Because of this, the absorption of laser light in the laser transmitting film is small and it is possible to efficiently irradiate the laser light through the laser transmitting film to the laser removal layer and to remove the laser transmitting film along with the laser removal layer.

As described, according to the present invention, because the terminal can be exposed by selectively irradiating laser light, it is possible to form the protection film over the entire surface of the substrate and cover the organic EL element with the protection film with superior coverage.

In addition, because it is possible to use, as the laser removal layer, the organic insulating layer used in the formation process of the organic EL element, it is possible to selectively form the laser removal layer over the terminal without adding a special process.

### BRIEF DESCRIPTION OF THE DRAWINGS

FIG. 1 is a diagram showing a planar structure of an active matrix organic EL panel according to a preferred embodiment of the present invention.

FIG. 2 is a diagram schematically showing a cross section along a line A-A of FIG. 1.

FIGS. 3A-3D are diagrams showing manufacturing steps of the active matrix organic EL panel according to a first preferred embodiment of the present invention.

FIG. 4 is a schematic cross-sectional view illustrating a method for manufacturing an active matrix organic EL panel according to a second preferred embodiment of the present invention.

FIG. 5 is a schematic cross-sectional view illustrating a method for manufacturing a passive matrix organic EL panel according to a third embodiment of the present invention.

### DESCRIPTION OF PREFERRED EMBODIMENTS

Preferred embodiments of the present invention (hereinafter simply referred to as “embodiments”) will now be described with reference to the drawings.

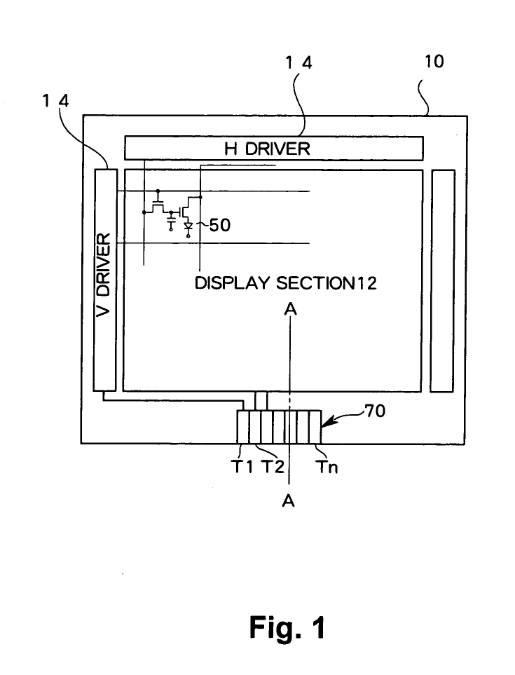

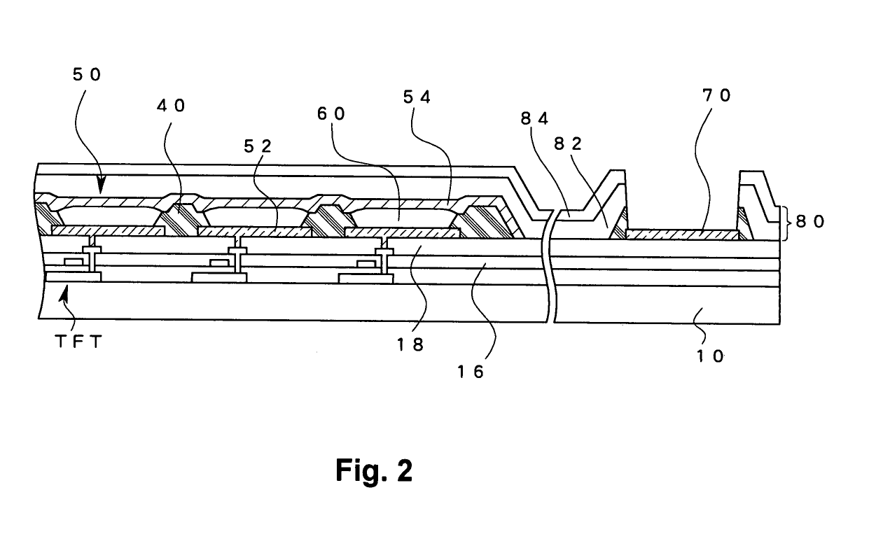

FIG. 1 is a diagram schematically showing a planar structure of an organic EL panel according to an embodiment of the present invention. FIG. 2 is a cross sectional view along a line A-A in FIG. 1.

A display section 12 in which a plurality of pixels are provided is formed over a panel substrate 10 made of a material such as glass. An organic EL element 50 is provided in each pixel. The organic EL element 50 has a structure in which an organic layer having emissive molecules is provided between a lower electrode and an upper electrode.

In this embodiment, the organic EL panel is of an active matrix type, and a switching element (here, a thin film transistor (TFT)) for individually controlling emission of an organic EL element 50 is formed in each pixel. In addition, one of the upper electrode and the lower electrode is connected to the TFT as a separate electrode for each pixel and the other of the electrodes is formed as a common electrode. In this embodiment, the lower electrode 52 is formed as a separate electrode and connected to the TFT. The lower electrode 52 is made of a transparent conductive material such as ITO (Indium Tin Oxide) and functions as an anode. The upper electrode 54 is made of a metal material such as Al and functions as a cathode. In this structure, the lower electrode 52, an organic layer 60, and the upper electrode 54 are layered in this order from the substrate. The lower electrode functions as an anode and the upper electrode functions as a cathode. Holes are injected from the anode and electrons are injected from the cathode so that the holes and electrons recombine in the organic layer to cause the organic emissive molecules to be excited, and light is emitted as the organic emissive molecules returns to their ground state. The light transmits through the transparent lower electrode 52 and the side of the panel substrate 10 and is emitted outside.

In the active matrix organic EL panel of this embodiment, a p-Si TFT, in which polycrystalline silicon is used in an active layer, is used as a pixel TFT. In addition, a driver circuit 14 for driving the pixel TFT is formed around the display section 12 over the panel substrate 10, the driver circuit 14 having p-Si TFTs with a similar structure to the pixel TFT and being formed approximately simultaneously with the pixel TFT.

In such a structure, various signals and power must be supplied to the organic EL panel formed over a glass substrate, such as, for example, a clock signal used in the driver circuit 14 for controlling each pixel TFT, a data signal supplied to the pixel TFT for determining an amount of light emission of each organic EL element 50, and a drive current source for actually supplying an electric current between the anode 52 and the cathode 54 of each organic EL element 50. For this purpose, as shown in FIG. 1, terminals 70 for external connection (Tl-Tn) are provided at the peripheral portion over the panel substrate 10. The terminals 70 in the completed panel are connected to an external signal supply source or an external power supply so that the panel can be used as a display device or a light emitting device.

The material of the terminal for external connection 70 is not limited as long as the material is conductive, but it is desirable to form the terminal for external connection simultaneously with wiring or an electrode using a conductive material used in the manufacturing process of the panel such as, for example, the material of the wiring or the electrode formed over the substrate 10. In this embodiment, as the material of the terminal, ITO which is identical to the material of the lower electrode 52 of the organic EL element 50 is used. When the ITO lower electrode 52 is patterned for each pixel, the terminal 70 is simultaneously formed at the peripheral region of the panel. Alternatively, it is also possible to form the terminal 70 using a material of a gate electrode of a TFT (for example, Cr) which is formed over the substrate 10 prior to the lower electrode 52 or using a material of the source electrode, drain electrode, or data signal line (for example, Al).

As already described, an organic EL element 50, in particular, the organic layer, is easily degraded by moisture or oxygen. In order to improve the lifetime and reliability of the element, therefore, it is necessary to prevent moisture and oxygen from intruding in to the organic layer from the outside. For this purpose, in this embodiment, after the upper electrode (here, a cathode) 54 of the organic EL element 50 is formed, a protection film 80 is formed over the entire surface, above the substrate 10, on which the element is formed to cover the organic EL elements 50.

In the embodiment, the protection film 80 has a multi-layered structure. On the side of the element, an SiO₂ layer 82 is formed through CVD using TEOS (tetraethoxysilan) as reaction gas, which has a superior surface coverage and which can be formed thickly. On the side of the outside, a SiNx layer 84 is formed which can be formed relatively thickly, is dense (and thus has a superior blocking capability with respect to moisture or the like), and has superior mechanical strength.

The protection film 80 is not limited to a multi-layered structure, but it is desirable that, in order to reliably cover the steps on the substrate including the organic EL element to as great an extent as possible, the protection film 80 be formed through a method for forming the film over the entire surface of the substrate. In the present embodiment, the protection film 80 is first formed to cover the entire substrate including the terminal 70. In addition, the materials for the protection film 80 are not limited to the TEOS (SiO₂) and SiNx, but in the present embodiment, the protection film 80 must have sufficient transmittance for laser light used for exposing the terminal as will be described below, such that the laser light can at least reach a planarizing insulting layer 40.

In the present embodiment, a laser removal layer is formed in the formation region of the terminal 70 above the terminal 70 and between the protection film 80 and the terminal 70, the laser removal layer being made of a material which selectively absorbs laser light irradiated to expose the terminal such that ablation occurs and the layer is automatically removed. With the use of the laser removal layer, in the present embodiment, after the protection film 8O is formed over the entire surface of the substrate, laser light is selectively irradiated onto the formation region of the terminal, the protection film 80 is removed along with the laser removal layer, and the terminal 70 is exposed.

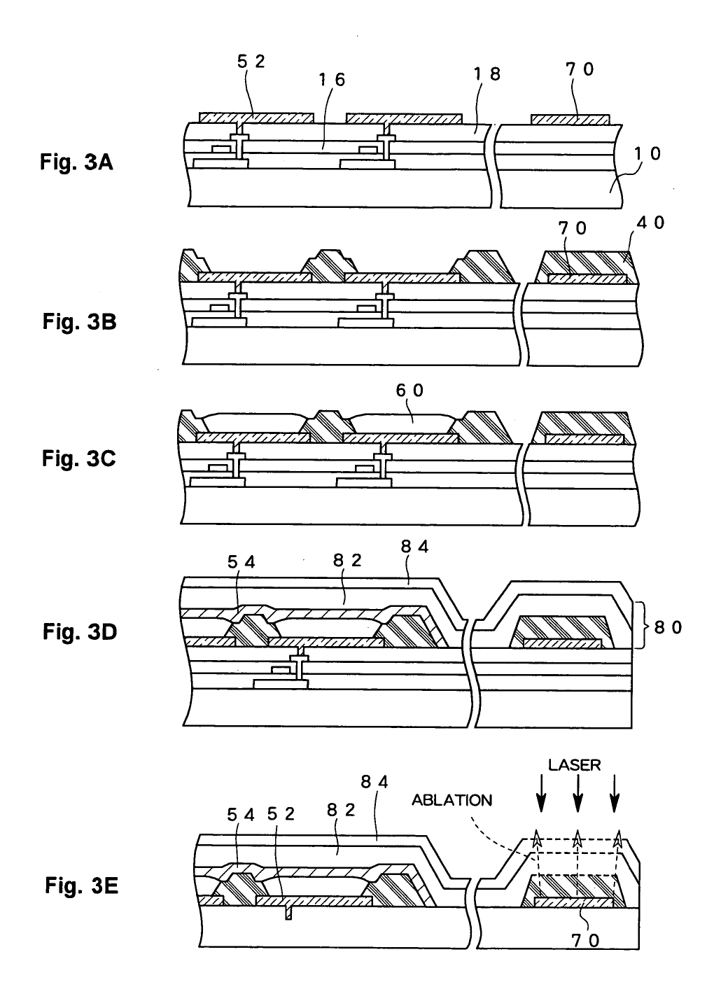

A method according to the present embodiment for removing the protection film 80 to expose the terminal will now be described referring to FIGS. 3A-3D.

As shown in FIG. 3A, after a TFT for controlling each organic EL element 50 is formed on a panel substrate 10 made of glass or the like, an interlayer insulating layer 16 is formed to cover the TFT and an electrode for controlling the TFT and wiring are formed. Then, a planarizing insulating layer 18 is formed to cover the entire surface of the substrate. After the planarizing insulating layer 18 is formed, contact holes are formed at required positions, and an ITO layer is layered, exposed to light, and etched so that the ITO layer is patterned into the shape of the lower electrode 52 of the organic EL element 50 and the shape of the terminal 70.

Then, as shown in FIG. 3B, a planarizing insulating layer 40 is formed to cover the end portions of the lower electrode 52. Because the lower electrodes 52 formed of ITO and which function as the anode are each connected to a TFT and thus patterned individually for each pixel, each pixel has end portions of the electrode. At the end portions of the lower electrode 52, concentration of electric field tends to occur, and, because the organic layer 60 is usually thin, there is a possibility that the anode and the cathode will be short-circuited, causing a display defect to occur. The planarizing insulating layer 40 is employed to solve this problem and, as shown in FIG. 3B, is formed to cover the ends of the lower electrodes 52 and to fill a gap between pixels. In the present embodiment, in addition to the end cover region for covering the lower electrode 52, a partially thick, mask supporting region which can support an evaporation mask is formed in the planarizing insulating layer 40 so that the evaporation mask used for forming the organic layer 60 through vacuum evaporation does not contact and damage already-formed layers of the organic layer having a multi-layered structure. The use of the planarizing insulating layer 40 is not limited to a case in which the organic layer 60 is formed through vacuum evaporation. It is also desirable to employ a similar planarizing insulating layer 40 for covering the end portions of the lower electrodes 52 and for separating pixels when an organic layer 60 is formed in each pixel through an inkjet method or various other printing methods.

The planarizing insulating layer 40 can be formed thickly. It is especially desirable that a material having a high flatness on the upper surface is used. An organic insulating material such as an acrylic resin is superior as the material of the planarizing insulating layer 40. The planarizing insulating layer 40 is formed by first layering the planarizing insulating layer 40 over the entire surface of the substrate covering the patterned lower electrodes 52 and then selectively etching and removing in a region other than the end portions of the formation region of the lower electrode 52, so that the lower electrode 52 is exposed. It is possible to mix, in advance, a photosensitive agent into the planarizing insulating material to be layered. Because the planarizing insulating material contains a photosensitive agent, when the planarizing insulating layer 40 is patterned, there is no need to separately form a resist material, and it is possible to directly expose the planarizing insulating layer 40 to light using a mask, to etch and obtain a desired pattern.

In this embodiment, when the planarizing insulating layer 40 is opened in a portion of each pixel corresponding to the emissive region to expose the surface of the lower electrode 52, the planarizing insulating layer 40 is not removed in the formation region of the terminal at the peripheral section of the panel so that the terminal 70 is covered by the planarizing insulating layer 40 and maintained in an unexposed state.

After the planarizing insulating layer 40 is formed and patterned, the organic layer 60 is formed over the exposed lower electrode 52 in each pixel. The organic layer 60 is a layer including at least an organic emissive material. For example, an organic layer 60 may have a multi-layered structure in which a hole injection layer, a hole transport layer, an emissive layer, and an electron transport layer are layered from the side of the anode (lower electrode) 52. When each layer in the organic layer 60 is formed through vacuum evaporation, the layers are formed using a suitable evaporation mask having a suitable opening for each pixel. In this manner, an organic layer 60 separated for each pixel by the planarizing insulating layer 40 as shown in FIG. 3D is formed. Regarding the selection of a single-layer structure or a multi-layered structure for the organic layer 60, or the determination as to whether or not the organic layer 60 should be patterned individually for each pixel, an optimum structure and an optimum pattern may be selected considering the material (s) to be used in the organic layer 60.

After the organic layer 60 is formed, an upper electrode 54 (cathode) common to all pixels is formed as shown in FIG. 3D. The upper electrode 54 is formed by layering, for example, Al through vacuum evaporation or the like. In a portion where the upper electrode is not required such as, for example, the portion of the panel outside the display section 12, the portion is covered, during the evaporation of Al, by an evaporation mask having an opening only for a region in which the electrode is to be formed, so that the Al layer is patterned into a desired shape simultaneously with the evaporation of Al.

After the components of the organic EL element 50 up to the upper electrode 54 are formed through processes as described, a protection film 80 is formed from above the upper electrode 54 to cover the entire surface of the substrate 10, on the side to which the elements are formed. As described before, the protection film 80 has a layered structure of, for example, a first protection film 82 made of SiO₂ by TEOS and a second protection film 84 made of SiNx. The first and second protection films 82 and 84 are formed, without the use of a metal mask or the like, over the entire surface of the substrate on the side to which the element is formed. Because of this, in the formation region of the terminal, the terminal 70 is covered by the protection film 80 with the planarizing insulating layer 40 therebetween which is formed to cover the terminal 70.

After the protection film 80 is formed, as shown in FIG. 3E, laser light is irradiated from the side of the substrate on which the element is formed toward the formation region of the terminal to expose the terminal 70. With the irradiation of laser light, the planarizing insulating layer 40 and the protection layer 80 covering the terminal 70 are removed, as shown in FIG. 2. In FIG. 3E, the TFT formation layers are not shown and only the layers above and including the anode 52 are shown for clarity. As the laser light to be irradiated, laser light is selected having a wavelength which is not absorbed by the materials of the protection layer 80 such as TEOS (SiO₂) or SiNx, is selectively absorbed by the material of the planarizing insulating layer 40 such as a synthetic resin, and does not reach the ITO terminal formed below the planarizing insulating layer 40.

By irradiating laser light of such a wave length, the planarizing insulating layer 40 formed to cover the formation region of the terminal absorbs the laser light and the planarizing insulating layer 40 covering the terminal 70 is quickly heated to cause ablation to occur, resulting in simultaneous removal of the laser-irradiated planarizing insulating layer 40 and the protection film 80 above the planarizing insulating layer 40. In this manner, the protection film 80 can be dry etched along with the planarizing insulating layer 40, and the terminal 70 formed below the planarizing insulating layer 40 can be selectively exposed in the formation region of the planarizing insulating layer 40. With the exposed terminal 70, it is possible to connect necessary signal sources and power supplies (for example, drive power supply, cathode power supply, etc.) to allow the panel to operate as a display device or a light emitting device. The irradiation region of the laser can be defined by adjusting the optical system so that the irradiation range becomes a predefined range, scanning the laser beam from the ends, or placing a mask between the laser light source and the panel, the mask having an opening only at the portion corresponding to the formation region of the terminal.

As the laser for selectively removing the planarizing insulating layer 40 and protection film 80 covering the terminal 70, it is possible to employ a YAG laser or an excimer laser. In particular, the YAG laser is desirable as the cost for a YAG laser device is low. Regarding the YAG laser, it is desirable to use a third harmonic (355 nm; base wavelength is 1064 nm). By using laser light having a wavelength of 355 nm, the laser light transmits through the protection film 80, is absorbed by the planarizing insulating layer 40, and does not reach the terminal 70 made of ITO or the like. Thus, it is possible to achieve a sufficient selection ratio between the terminal 70 and the planarizing insulating layer 40 to be removed and to reliably remove the planarizing insulating layer 40 and the protection film 80 covering the terminal 70 without damaging the terminal 70.

When laser light having an optimum wavelength is used as the laser to be irradiated, because the laser light does not reach the terminal 70 when the laser is irradiated from the side of the protection film 80, the material of the terminal 70 is not limited to the same material as the upper electrode 52 (anode) of the organic EL element 50 such as ITO, and it is also possible to use a metal material identical to that of the gate electrode of the TFT or that of the signal line such as a data line. In addition, by using laser light having an optimum wave length as the laser light to be irradiated, it is also possible to irradiate the laser light from the side of the glass substrate so that the laser light transmits through the ITO film and causes ablation to occur in the planarizing and insulating layer, resulting in removal of the protection film and the planarizing insulating layer.

As an alternative embodiment, a method for exposing a terminal will now be described in which a metal material is used in one or more layers, for example, in the outermost layer, of the protection film 80 having a layered structure.

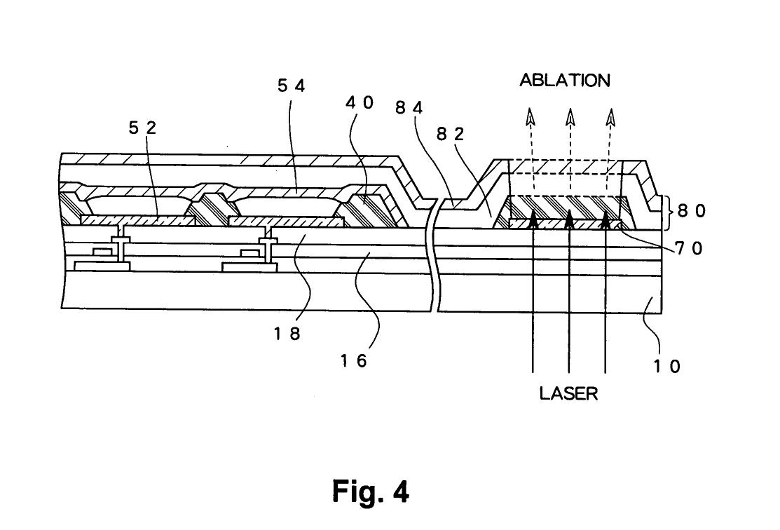

When the protection film 80 contains a metal material layer as in this case, laser light cannot transmit through the protection film 80. Therefore, in this embodiment, the laser is irradiated not from the side of the protection film 80, but rather, from the side of the transparent panel substrate 10 such as glass toward the terminal, as shown in FIG. 4.

As the laser to be used in this case, similar to the first embodiment, it is possible to employ, for example, YAG laser, but in this embodiment, laser light of a longer wavelength such as a second harmonic (532 nm) is preferably used. In addition, as the material of the terminal 70, a transparent conductive material such as ITO is desirable. Moreover, as the material for the planarizing insulating layer 18 formed below the lower electrode 52 of the organic EL element 50, it is desirable to use a material which does not absorb laser light such as TEOS (SiO₂).

With a structure satisfying these conditions, when laser light of a wavelength of approximately 532 nm is irradiated from the side of the substrate 10, the laser light transmits through the layers from the glass substrate 10 to the ITO terminal 70 and is absorbed by the planarizing insulating layer 40 covering the ITO terminal 70. Furthermore, the laser light transmits through the planarizing insulating layer 40 to some extent, but the transmitted laser light is reflected and absorbed by the metal layer in the protection film 80.

Therefore, in this case also, the planarizing insulating layer 40 covering the ITO terminal 70 absorbs the laser light and ablation occurs, allowing for removal of the protection film 80 formed above the planarizing insulating layer 40 along with the layer 40, and for exposure of the surface of the ITO terminal 70.

As another alternative embodiment to an active matrix organic EL panel as described in the first and second embodiments, a method for exposing a terminal in a passive matrix organic EL panel will now be described.

In a passive matrix organic EL panel, a TFT as described above regarding the first and second embodiments is not formed in each pixel. Instead, a pixel comprises an organic EL element having a diode structure and which is formed in a region where one of lower electrodes formed over the substrate in a stripe pattern and one of upper electrodes formed over the substrate in a stripe pattern intersect with an organic layer formed therebetween.

In such passive matrix organic EL panel, similar to the active matrix organic EL panel, sometimes, the organic layer, at least the emissive layer within the organic layer, is separated for each pixel to prevent emission blotting between pixels and prevent color mixture in a full-color panel. In this case, after the lower electrode (here, a transparent anode) 52, an organic insulating layer is formed which is made of a material such as an acrylic resin containing a photosensitive agent and which is used for the planarizing insulating layer 40 in the first and second embodiments.

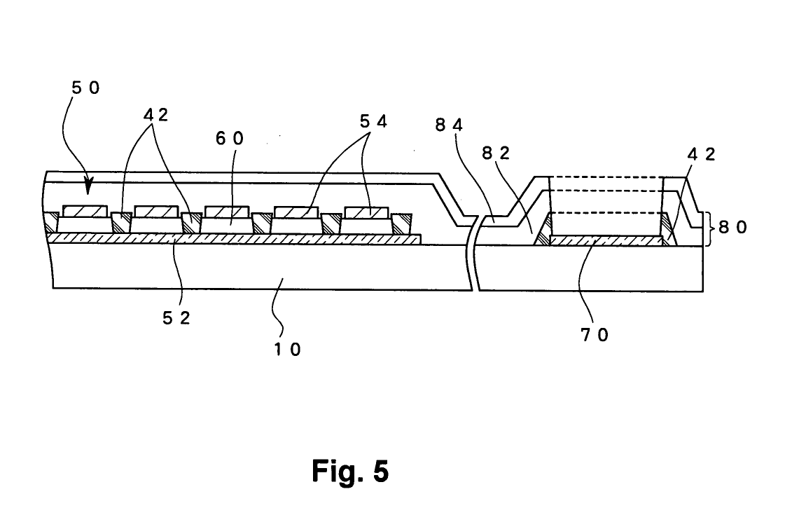

FIG. 5 schematically shows a cross section of a passive matrix organic EL panel according to the present embodiment along a lower electrode 52. Over the lower electrode 52 extending along the row direction, a base layer 42 is formed for each pixel region, which is made of an organic insulating material, has a reverse-tapered cross section, and extends along the column direction. On the peripheral region of the panel substrate, a terminal 70 made of the same material as the lower electrode 52 such as, for example, ITO is formed during formation of the lower electrode 52 of the organic EL element 50. When the base layer 42 is patterned, the base layer 42 which absorbs laser light is selectively not removed over the terminal 70.

After the base layer 42 is formed and patterned, an organic layer 60 is layered through vacuum evaporation or the like using an evaporation mask if necessary. Because a plurality of base layers 42 are formed for one lower electrode 52 in a direction crossing the lower electrode 52, the organic layer 60 is separated for each column by the base layers 42.

Over the organic layers 60 separated by the base layers 42, upper electrodes 54 made of Al or the like are formed in a stripe-shape extending along the base layer 42 and along the column direction. Each pixel is formed at a portion in which an upper electrode 54 and a lower electrode 52 intersect each other with the organic layer 60 therebetween.

After the upper electrode 54 is formed, a protection film 80 similar to that used in the first embodiment is formed to cover the entire surface, including the upper electrode, of the substrate on the side on which the element is formed. The protection film 80 also covers the base layer 42 formed on the terminal 70.

After the protection film 80 is formed, similar to the above-described first embodiment, for example, a third harmonic of the YAG laser light is selectively irradiated onto the formation region of the terminal 70 from the side of the protection film 80. With this process, the base layer 42 formed of the organic insulating material and covering the terminal 70 similar to the first embodiment is heated and ablation occurs, resulting in simultaneous removal of the protection film 80 and the base layer 42 to expose the terminal 70.

What is claimed is:

1. A method for manufacturing an organic electroluminescence panel having an organic electroluminescence element and a terminal for external connection for driving the organic electroluminescence element, the organic electroluminescence element having an organic layer including a light emitting molecule between a lower electrode and an upper electrode, wherein
a laser removal layer made of a laser absorbing material is formed to cover a formation region of the terminal for external connection;
after the laser removal layer is formed, a protection film is formed to cover the organic electroluminescence element and the laser removal layer; and
laser light having a wavelength in an absorption wavelength range of the laser absorbing material is irradiated toward a region in which the laser removal layer is formed so that the laser removal layer and the protection film formed above the laser removal layer are removed and an upper surface of the terminal for external connection is exposed.

2. A method for manufacturing an organic electroluminescence panel according to claim 1, wherein
an organic insulating layer is formed at least partially covering end portions of each of the lower electrodes formed individually for each pixel, and, simultaneously, the organic insulating layer is formed over the formation region of the terminal for external connection as the laser removal layer.

3. A method for manufacturing an organic electroluminescence panel according to claim 2, wherein
the organic insulating layer is a planarizing insulating layer containing a photosensitive material.

4. A method for manufacturing an organic electroluminescence panel according to claim 2, wherein
the protection film is a laser transmitting film which allows the laser light to transmit through and is removed along with the laser removal layer when the laser light is irradiated.

5. A method for manufacturing an organic electroluminescence panel according to claim 1, wherein
a plurality of organic electroluminescence elements are formed on the panel substrate; and
an organic insulating layer is formed to separate, by each lower electrode or by each upper electrode, at least a portion of the organic layer of the organic electroluminescence element, and the organic insulating layer is simultaneously formed over the formation region of the terminal for external connection as the laser removal layer.

6. A method for manufacturing an organic electroluminescence panel according to claim 1, wherein
the laser removal layer is a planarizing insulating layer containing a photosensitive material.

7. A method for manufacturing an organic electroluminescence panel according to claim 1, wherein
the protection film is a laser transmitting film which allows the laser light to transmit through and is removed along with the laser removal layer when the laser light is irradiated.
